(19) United States
(12) Patent Application Publication
(10) Pub. No.: US 2017/0282412 A1
(43) Pub. Date: Oct. 5, 2017

(54) COMPONENT WITH CUSTOMIZED EXTERIOR SURFACE AND METHOD OF MANUFACTURE

(71) Applicant: GM GLOBAL TECHNOLOGY OPERATIONS LLC, Detroit, MI (US)

(72) Inventors: Thomas J. Pickett, Warren, MI (US); David M. Trush, Troy, MI (US)

(73) Assignee: GM GLOBAL TECHNOLOGY OPERATIONS LLC, Detroit, MI (US)

(21) Appl. No.: 15/216,788

(22) Filed: Jul. 22, 2016

Related U.S. Application Data
(60) Provisional application No. 62/316,207, filed on Mar. 31, 2016.

(51) Int. Cl. B29C 33/42; B29C 49/48; B29C 59/16; B29C 43/36; B29C 59/02; B29C 45/37; B29C 51/36

(52) U.S. Cl. CPC B29C 33/424; B29C 45/372; B29C 49/48; B29C 51/36; B29C 43/36; B29C 59/02; B29C 59/16; B29C 2049/4879; B29L 2031/3005

(57) ABSTRACT

A component with a customized exterior surface and a method and tool for manufacturing the same are provided. The component may be formed via a plastic forming process with a forming tool, such that it has a surface texture formed on its exterior surface. The forming tool has at least one tool surface, which defines a mold cavity. The tool surface has a textured layer coupled thereto, such that the textured layer directly contacts a moldable material supplied to the mold cavity. The textured layer has a surface texture formed thereon resulting in the surface texture present on the textured layer being transferred to and formed on the exterior surface of the component during forming. The textured layer may be changeable or replaceable with respect to the at least one tool surface, such that a single tool may form components with different surface textures formed on the exterior surface thereof.

### CROSS-REFERENCE TO RELATED APPLICATIONS

This application claims the benefit of U.S. Provisional Application No. 62/316,207, filed Mar. 31, 2016, which is hereby incorporated by reference in its entirety.

### TECHNICAL FIELD

The disclosure relates to components with a customized exterior surface and a method of manufacturing the same with a forming tool.

### BACKGROUND

A variety of polymeric components can be formed by manufacturing tooling, such as, tooling for injection molding, thermoforming, compression molding, and blow molding. Such tools typically have a plurality of mold surfaces that combine to define a mold cavity. In turn, the tool produces polymeric components with a single uniform exterior surface texture or finish in the shape of the mold cavity. It is desirable, in some applications, to customize the exterior surface texture or finish of these components for use in different applications.

### SUMMARY

A component with a customized exterior surface and a method of manufacturing the same with a forming tool are provided. The component includes a component body structure. The body structure has an exterior surface. The exterior surface has a surface texture formed thereon.

The component is composed of a polymeric material and is manufactured with a forming tool via a suitable plastic forming process, such as injection molding, compression molding, blow molding, thermoforming, and vacuum forming. As such, the component may be formed via a forming tool suitable for use in injection molding, thermoforming, compression molding, blow molding, and vacuum forming. The forming tool may have a plurality of tool surfaces, which define a mold cavity in the shape of the component body.

The at least one tool surface may have a textured layer coupled thereto, such that the textured layer directly contacts the material defining the component during the forming process. Therefore, the surface texture present on the textured layer is transferred to the exterior surface of the component body during forming due to the contact between the material defining the component exterior surface and the textured layer. The textured layer may be changeable and/or replaceable with respect to the at least one tool surface.

The method of manufacturing the component with a customized exterior surface includes at least the following steps: selecting a textured layer having a selected surface texture formed thereon; selecting a forming tool having at least one tool surface that defines a mold cavity; coupling the textured layer to the at least one tool surface; and supplying a moldable polymeric material into the mold cavity to form the component body structure in the shape of the mold cavity, such that the polymeric material contacts the textured layer applied to the at least one tool surface, such that the surface texture of the textured layer is transferred to and formed on the exterior surface of the component.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic perspective view of an example component with an exterior surface that is without a surface texture formed thereon.

FIG. 2 is a schematic perspective view an example component with an exterior surface having a surface texture formed thereon.

FIG. 3A is a schematic perspective view an example component, embodied as an automotive trim piece, having a design formed on its exterior surface, such that a first portion of the exterior surface of the component, within the design, has a surface texture formed thereon and a second portion of the exterior surface outside the design does not have a surface texture formed thereon.

FIG. 3B is a schematic perspective view an example component, embodied as an automotive trim piece, having a design formed on its exterior surface, such that the first portion of the exterior surface of the component within the design, does not have a surface texture formed thereon and the second portion of the exterior surface of the component, outside the design, has a surface texture formed thereon.

FIG. 4A is a schematic cross-section view of an example injection molding tool having a plurality of molding surfaces.

FIG. 4B is a schematic cross-section view of an example injection molding tool having a plurality of molding surfaces that cooperate to define a molding cavity, with an example formed component.

FIG. 5 is a schematic cross-section view of an example blow molding tool having at least one molding surface defining a molding cavity.

FIG. 6 is a schematic cross-section view of an example thermoforming tool having at least one molding surface defining a molding cavity.

FIG. 7 is a schematic cross-section view of an example compression molding tool having at least one molding surface defining a molding cavity.

FIG. 8 is a flow diagram detailing the present method of manufacturing a polymeric component with a forming tool, including process of tailoring the forming tool to form a variety of example components having customized exterior surfaces.

FIG. 9 is a flow diagram further detailing the step of supplying a moldable polymeric material into the mold cavity to form the component body in an example blow molding process.

FIG. 10 is a flow diagram further detailing the step of supplying a moldable polymeric material into the mold cavity to form the component body in an example thermoforming process.

FIG. 11 is a flow diagram further detailing the step of supplying a moldable polymeric material into the mold cavity to form the component body in an example compression molding process.

### DETAILED DESCRIPTION

While the present disclosure may be described with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

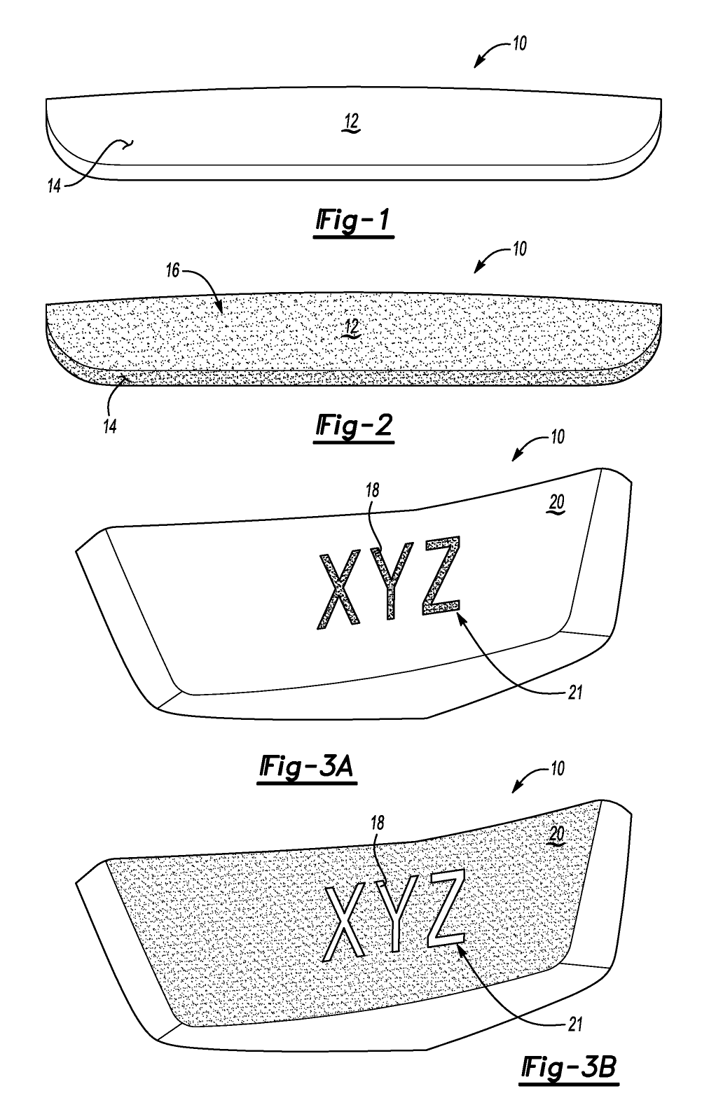

Referring to the drawings, wherein like reference numerals refer to like components throughout the several views, a polymeric component 10 and a method of manufacturing 100 the same with a forming tool 22 are provided. Referring specifically to FIGS. 1-3B, the component 10 may be composed of a suitable high-strength moldable material 60. For example, high-strength moldable material 60 may be a polymeric material, and more specifically may be a thermoplastic material.

The component 10 has a component body 12 having an exterior surface 14. The exterior surface 14 of the component body 12 may be smooth or without surface texture 16, as shown in FIG. 1. The exterior surface 14 of the component body 12 may have a surface texture 16 formed thereon as shown in FIGS. 2, 3A, and 3B. As shown in FIG. 2, the surface texture 16 may cover substantially the entirety of the exterior surface 14, or as shown in FIGS. 3A and 3B, the surface texture 16 may only be formed on one portion of the exterior surface 14. As shown in FIG. 3A, a first portion 18 of the exterior surface 14 has the surface texture 16 formed thereon and a second portion 20 of the exterior surface 14 is smooth or without surface texture. As shown in FIG. 3B, the first portion 18 of the exterior surface 14 is smooth or without surface texture 16 and the second portion 20 of the exterior surface 14 has the surface texture 16 formed thereon.

As shown further in FIGS. 3A and 3B, the first portion 18 may be embodied as a personalized or customized design 21. For example, the component 10 may be customized with the name of the purchaser, the manufacturer's logo, the manufacturer's brand name, or another desired textual and/or graphic design. In one example, the surface texture 16 may be present in only the first portion 18 of the exterior surface 14 and the second portion 20 of the exterior surface 14 may be smooth or without surface texture 16, e.g., a textured logo could be formed on an otherwise smooth polymeric component 10 (FIG. 3A). In another example, the surface texture 16 may be present in only the second portion 20 of the exterior surface 14 and the first portion 18 of the exterior surface 14 within the design 21 may be smooth or without surface texture 16, e.g., a smooth logo (void of surface texture) may be formed on the exterior surface 14 of the polymeric component 10, wherein the remaining exterior surface 14 outside of the design 21 has the surface texture 16 formed thereon (FIG. 3B).

Surface textures 16 are usefully applied to the exterior surface 14 of a variety of polymeric components 10 including, but not limited to, exterior panels for home appliances, sporting balls, playground equipment, and automotive body panels and trim pieces. Such polymeric components 10 may be formed by a plastic forming process such as, but not limited to, injection molding, blow molding, thermoforming, and vacuum molding. Surface textures 16 applied to the exterior surfaces 14 of such polymeric components 10 are desirable to enhance the aesthetic qualities of the component 10 and obscure sink marks, sink wells, or other potential blemishes or imperfections created during formation or molding.

Surface textures 16 may be applied to the exterior surface 14 of formed polymeric components 10 with a forming tool 22 having at least one tool surface 24, such that the tool surfaces 24 cooperate to define a mold cavity 26. Conventionally, the tool surfaces 24 are pre-grained, i.e., machined with a single specific texture 16 or grain thereon or left smooth or without surface texture 16. Such a configuration of the forming tool 22 and tool surfaces 24 allows for only the particular surface texture 16 or grain machined onto the respective tool surfaces 24 to be applied to the exterior surface 14 of the resultant components 10 over the life of the tool 22, unless the tool surfaces 24 are re-grained, i.e., machined with an alternate single specific surface texture 16 or grain thereon. Changing the surface texture 16 or grain on the tool surfaces 24 is a very expensive and time consuming process.

Thus, in essence, a tool 22 that produces components 10 with the single specific surface texture 16 formed on the respective tool surface 24 cannot produce components 10 having differing surface textures 16 formed on the exterior surface 14; this limits the ability to freely view a variety of surface textures 16 on a particular component 10 during the design phase, e.g., a designer cannot produce a variety of prototypes with different textures formed on the exterior surface 14 of the component 10 to determine which surface texture 16 is best suited for the particular application. Rather, different grains are likely viewed and evaluated, for example, on two-dimensional grain plaques instead of on the resultant three-dimensional components 10 themselves. Further, a particular surface texture 16 or grain is likely to be selected for machining on the respective tool surface 24 for production in advance of the production of a prototype. Further, after a surface texture 16 is selected for production, changes to the surface texture 16 applied to respective components 10 are substantially precluded due to the cost and time necessary to re-machine the tool surface 24 of a dedicated tool 22 with a single surface texture 16 formed on the tool surface 24.

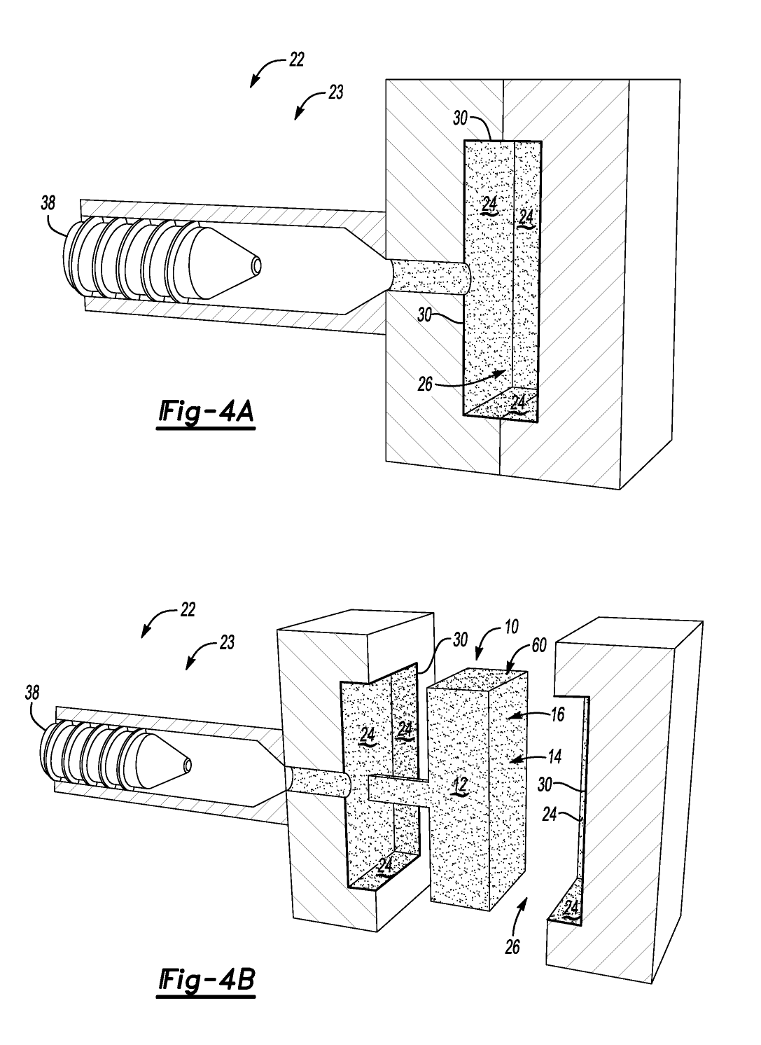

Referring to FIGS. 4A-7 and FIG. 8, the component 10 of the present disclosure may be formed with the forming tool 22 via the present method 100 of manufacturing a component 10 having a component body 12 with an exterior surface 14. The present method 100 allows for the manufacturing of components 10 with differing surface textures 16 formed thereon with the same tool 22. Such an application is useful in the design process, as designers may produce prototypes having various surface textures 16 with the same forming tool 22, to view sample components 10 with a variety of surface textures 16 formed on the exterior surface 14 thereof prior to making a final selection with regard to the surface texture 16 of the resulting components 10. Further, in an automotive context, the present method allows automotive body panels and trim pieces for different vehicle makes, models, and trim levels having the same shape and dimension, but different surface texture 16 formed on the exterior surface 14 thereof, to be formed using the same forming tool 22 within the same production period. The present method 100 also allows for personalization of the resultant components 10. The method 100 comprises the following steps.

As shown in the flow chart in FIG. 8, at step 101, a desired surface texture 16 for the component 10 is selected. Surface textures 16 may be selected based on aesthetics, durability, and the like.

At step 102, a textured layer 30 having the selected surface texture 16 formed thereon is selected. The textured layer 30 may be one of a textured film and a textured tape. In embodiments where the textured layer 30 is a textured film, the textured film may be a polymer film, plastic film, a polyamide film, a polyimide film, a polyethylene film, a thermoplastic polyurethane (TPU) film, or the like. In the case of a polyethylene film, the film may be one of, but is not limited to, a high-density polyethylene film, a low-density polyethylene film, and a linear low-density polyethylene (LLPE) film.

In embodiments where the textured layer 30 is a textured tape, the textured tape may be a commercially available textured tape such as, but not limited to, one of a textured vinyl tape, a textured polyethylene tape, a textured foil tape, a textured fabric tape, and textured cloth tape. The textured tape may be a commercially available paper-based tape such as a masking tape or the like. The textured tape may be a commercially available textured vinyl tape, such as duct tape or the like. The textured tape may be a polyvinyl chloride tape. The vinyl tape or polyvinyl chloride tape may also contain a mineral abrasive grit to enhance the surface texture 16. In the case of a polyethylene tape, the tape may be one of, but is not limited to, a high-density polyethylene tape, a low-density polyethylene tape, and a linear low-density polyethylene (LLPE) tape.

In some instances, the textured layer 30 may be pre-formed with the selected surface texture 16 thereon. In other instances, the textured layer 30 may need the selected texture 16 applied thereto. In such cases, the step of selecting a textured layer 30 having the selected surface texture 16 may further include: applying the selected surface texture 16 to the textured layer 30. The selected surface texture 16 may be applied to the textured layer 30 via embossing, debossing, stamping, molding, application of a textured release paper, laser etching of a film, or the like.

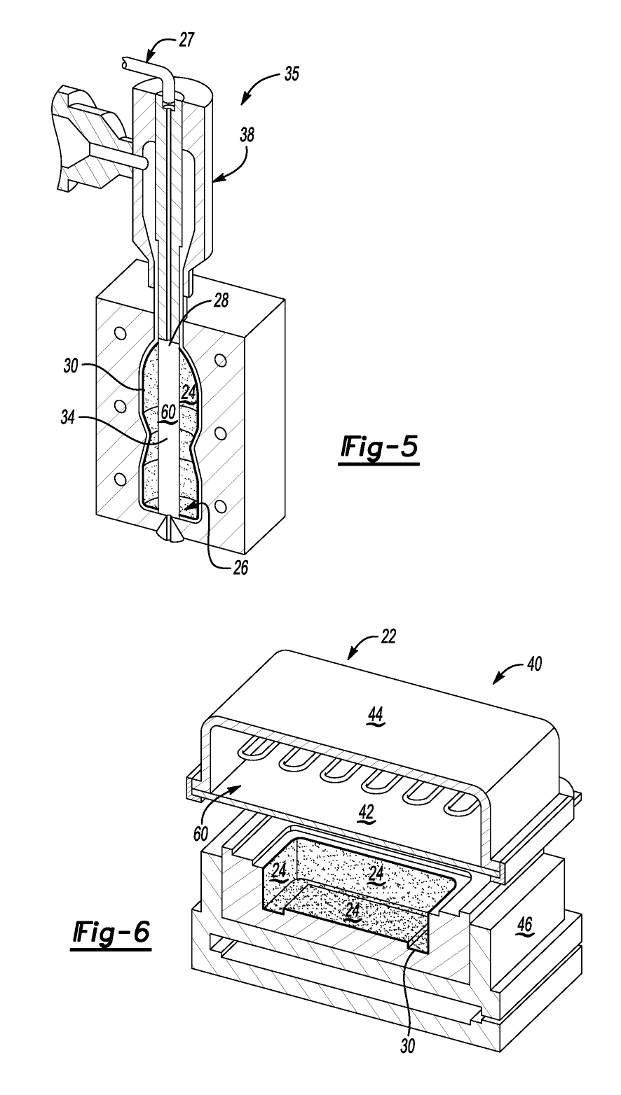

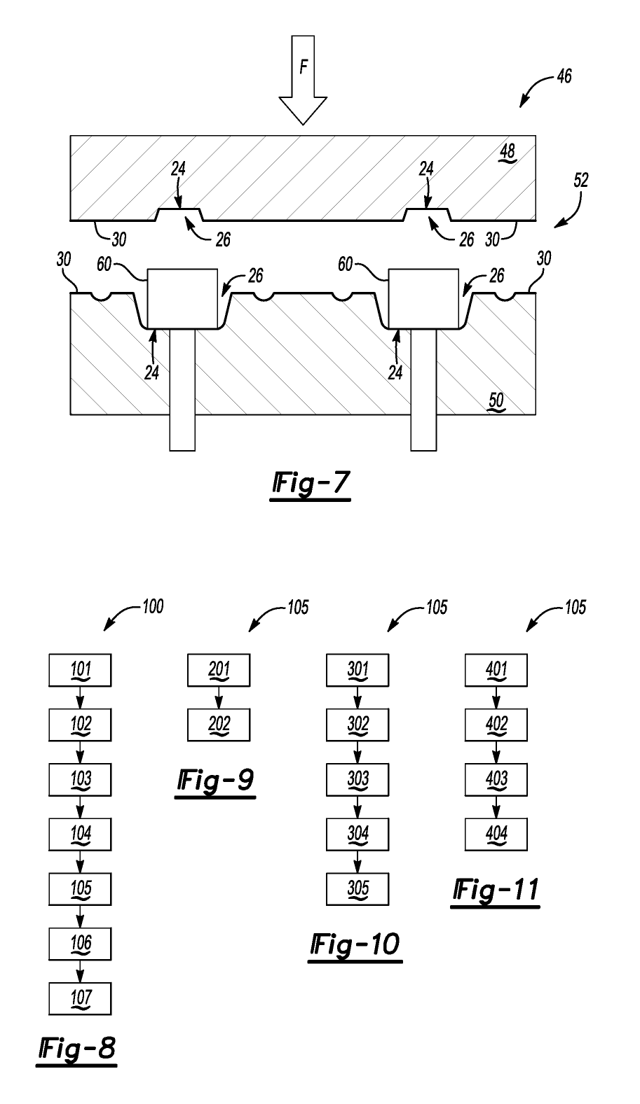

At step 103, a plastic forming tool 22 is selected. The plastic forming tool 22 has a plurality of tool surfaces 24. The tool surfaces 24 cooperate to define a mold cavity 26, such that the shape of the mold cavity 26 defines the shape of the exterior surface 14 of the resultant component 10. The plastic forming tool 22 may be one of an injection molding machine 23 (FIGS. 4A and 4B), a blow molding machine 35 (FIG. 5), a thermoforming machine 40 (FIG. 6), a vacuum forming machine, a compression molding machine 46 (FIG. 7), or another suitable plastic forming machine.

At step 104, the textured layer 30 is coupled to the at least one tool surface 24 of the selected forming tool 22. The textured layer 30 may be coupled to the tool surfaces 24 via an adhesive layer applied between the textured layer 30 and the tool surface 24 or formed within the underside of the textured layer 30. A respective textured layer 30 may be utilized to form a plurality of like-textured components in relative succession. However, the textured layer 30 is readily removable from the respective tool surface 24. Further, the textured layer 30 may be readily replaced by an alternative textured layer 30 on the same tool surface 24. Simply stated, a first textured tape or textured film may be coupled to the respective tool surface 24 prior to the forming of a first component 10 and removed or interchanged thereafter. A second textured tape or textured film of the same or a different selected surface texture 16 may be coupled to the respective tool surface 24 prior to the forming a second component, etc. The removable and interchangeable nature of the textured layer 30 allows several components 10 having different selected surface textures 16 formed on the exterior surface 14 thereof, to be formed by the same forming tool 22 in relative succession.

In one example, shown in FIG. 2, the textured layer 30 may be coupled to the at least one tool surface 24, such that the textured layer 30 covers substantially the entirety of the respective tool surface 24, i.e., the textured tape or textured film is applied to the entirety of the tool surface 24 to produce a component 10 with a uniform surface texture 16 formed on the entirety of its exterior surface 14.

In another example, shown in FIGS. 3A and 3B, the textured layer 30 may be selectively coupled to only a portion of the respective tool surface 24. For example, the tool surface 24 may have a first portion and a second portion. The first portion of the tool surface 24 corresponds to the first portion 18 of the exterior surface 14 of the component 10. The second portion of the tool surface 24 corresponds to the second portion 20 of the exterior surface 14 of the component 10.

As shown in FIG. 3A, the textured layer 30 is applied within only the first portion of the tool surface 24 to thereby form a component 10 having a first portion 18 of its exterior surface 14 with a surface texture 16 formed thereon and the second portion 20 of its exterior surface being smooth, i.e., void of texture. The textured layer 30 may be arranged on the respective tool surface 24 in a predetermined design 21. The design 21 may be covered by the textured layer 30. As such, the first portion of the respective tool surface 24 is defined by the design 21, which is transferred to and formed on the first portion 18 of the exterior surface 14 of the component 10 with the selected surface texture 16. In this, example, the second portion of the respective tool surface 24 may remain smooth, i.e., is not covered by the textured layer 30. As such, the resulting component 10 may have an exterior surface 14 that has a surface texture 16 formed on the first portion 18 of its exterior surface 14 in the form of the design 21, and has a second portion 20 that is smooth or void of texture. The design 21 may be embodied as the purchaser's name, the manufacturer's logo, the manufacturer's brand name, or any other customized textual and/or graphic design.

Alternatively, as shown in FIG. 3B, the textured layer 30 is applied to only the second portion of the tool surface 24 to thereby form a component 10 having a second portion 20 of its exterior surface 14 with a surface texture 16 formed thereon and the first portion 18 of its exterior surface 14 being smooth, i.e., void of texture. The textured layer 30 may be arranged on the respective tool surface 24 outside a predetermined design 21. The design 21 may be uncovered by the textured layer 30 and the remainder of the tool surface 24 may be covered by the textured layer 30. As such, the first portion of the respective tool surface 24 is defined by the design 21, which is transferred to the first portion 18 of the component 10 with a smooth surface. In this, example, the second portion of the respective tool surface 24 may be covered by the textured layer 30. As such, the resulting component 10, may have an exterior surface 14 that has a surface texture 16 formed on the second portion 20 of its exterior surface 14 surrounding the design 21, and has a first portion 18 defined by the design 21 that is smooth or void of texture. The design 21 may be embodied as the purchaser's name, the manufacturer's logo, the manufacturer's brand name, or any other customized textual and/or graphic design.

The at least one tool surface 24 may, alternatively, have a grained surface, which produces a surface texture 16 on the exterior surface 14 of the component 10 that is not desired. In this instance, in one example, a textured layer 30 may be coupled to or applied over the pre-grained tool surface 24, in order to change the surface texture 16 formed on the exterior surface 14 of the resultant component 10 formed by the respective forming tool 22. In another example, a smooth layer 30 may be coupled to or applied over the pre-grained tool surface 24, in order to change the surface texture 16 formed on the exterior surface 14 of the component 10 formed by the respective forming tool 22. In this instance, a pre-grained tool surface 24, would produce a component 10 with a smooth exterior surface 14, i.e., without a surface texture 16 formed thereon.

After the textured layer 30 having the predetermined surface texture 16 formed thereon is applied to the at least one tool surface 24, at step 104, at step 105 a high-strength moldable polymeric material 60 is supplied to the mold cavity 26 of the forming tool 22 to form the component body 12 in the shape of the mold cavity 26. The high-strength moldable material 60 may be a thermoplastic material, a thermosetting material, or the like. The high-strength moldable material 60 is supplied to the mold cavity 26, such that the material fills the mold cavity 26 and contacts the textured layer 30 coupled to the at least one tool surface 24. The high-strength moldable material 60 may be supplied to the mold cavity 26 at a temperature of from about 155 degrees Celsius to about 170 degrees Celsius. The respective tool surfaces 24 may be cooled via water jackets or the like to maintain a forming temperature of from about thirty-five (35) degrees Celsius to about fifty-five (55) degrees Celsius. Upon contact between the high-strength moldable material 60 and the textured layer 30, the predetermined surface texture 16 formed on the textured layer 30 is transferred to and formed on the exterior surface 14 of the component 10.

In a first example, when the plastic forming process is an injection molding process, and the forming tool 22 is an injection molding machine 23 (FIGS. 4a, 4b), step 105, i.e., supplying a high-strength moldable material 60 into the mold cavity 26 to form the component body 12 further includes: injecting the high-strength moldable material 60 into the mold cavity 26 via an injector 38, e.g., a ram or a screw-type plunger to force the moldable material 60 into the mold cavity 26. The moldable material 60 then solidifies within the mold cavity 26. When formed to the shape of the mold cavity 26, the moldable material 60 contacts the textured layer 30 coupled to the at least one tool surface 24, such that the selected surface texture 16 formed on the textured layer 30 is transferred to and formed on the exterior surface 14 of the formed component 10.

As detailed in FIG. 9, in a second example, when the plastic forming process is a blow molding process and the forming tool 22 is a blow molding machine 35 (FIG. 5), step 105 i.e., supplying a high-strength moldable material 60 into the mold cavity 26 to form the component body 12 further includes the following steps. At step 201, a thermoplastic preform 34 (FIG. 5) is inserted into the mold cavity 26. The thermoplastic preform 34 may be a tube-like piece of moldable material 60 defining a cavity in one end through which compressed air may pass. At step 202, compressed air is injected into the cavity defined by the thermoplastic preform 34 via an injector 38, e.g., an air hose 27 and nozzle 28, to push the moldable material 60 out to contact the textured layer 30 coupled to the at least one tool surface 24, such that the selected surface texture 16 formed on the textured layer 30 is transferred to and formed on the exterior surface 14 of the formed component 10. A blow molding process is suitable for forming components 10 having an interior void, i.e., hollow components.

As detailed in FIG. 10, in a third example, when the plastic forming process is a vacuum forming or thermoforming process and the forming tool 22 is a vacuum forming or thermoforming machine 40 (FIG. 6), step 105 i.e., supplying a high-strength moldable material 60 into the mold cavity 26 to form the component body 12 further includes the following steps. At step 301, a thermoplastic sheet 42 is inserted into the mold cavity 26 between a first machine portion 44 and a second machine portion 46. At step 302, the thermoplastic sheet 42 is heated to a first predetermined temperature, e.g., a pliable forming temperature.

At step 303, the thermoplastic sheet 42 is deformed to the shape of the mold cavity 26 or the desired shape of the component 10. When deformed or stretched to the shape of the mold cavity 26, the thermoplastic sheet 42 contacts the textured layer 30 coupled to the at least one tool surface 24, such that the selected surface texture 16 formed on the textured layer 30 is transferred to and formed on the exterior surface 14 of the formed component 10.

At step 304, the deformed thermoplastic sheet is cooled to a second predetermined temperature. Once cooled and solidly formed at step 304, the thermoplastic sheet 42 is trimmed of excess material to form the component 10, at step 305.

As detailed in FIG. 11, in a fourth example, when the plastic forming process is a compression molding process and the forming tool 22 is a compression molding machine 46 (FIG.7), step 105 i.e., supplying a high-strength moldable material 60 into the mold cavity 26 to form the component body 12 further includes the following steps. At step 401, the high-strength moldable material 60 is disposed between a first compression molding machine portion 48 and a second compression molding machine portion 50, within the mold cavity 26, wherein the mold cavity 26 is in an open position 52. At step 402, the open mold cavity 26 is pre-heated to a predetermined pre-heating temperature, when the cavity is in the open position 52.

At step 403, the mold cavity 26 is closed by applying a force F to the first compression molding machine portion 48, which forces the high-strength moldable material 60 into the mold cavity 26, such that the high-strength moldable material 60 contacts the textured layer 30 coupled to the at least one molding surface 24.

At step 404, the high-strength moldable material 60 is cured within the mold cavity 26, wherein the mold cavity 26 remains in the closed position. Curing the high-strength moldable material 60 includes heating the moldable material 60 to a predetermined curing temperature and applying a predetermined curing pressure to the moldable material 60 with the first compression molding machine portion 48 and the second compression molding machine portion 50 for a predetermined amount of time.

The present method 100 continues after formation of the component 10 at step 106. At step 106, the component 10 is removed from the mold cavity 26.

At step 107, the textured layer 30 is decoupled from the at least one tool surface 24, such that the textured layer 30 is removed from the respective tool surface 24.

Optionally, steps 101-105 can be repeated. Notably, in repeating steps 101-105, at step 101, the selected surface texture 16 may be different from the selected surface texture 16 of the preceding iterations of the present method 100. Simply stated, each molded component 10 may have a different surface texture 16 formed on its exterior surface 14 than the components 10 previously formed by the same tool 22.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method of manufacturing a component having a component body with an exterior surface, the method comprising the steps of:
selecting a textured layer having a selected surface texture formed thereon;
selecting a forming tool having at least one tool surface, such that the at least one tool surface defines a mold cavity;
coupling the textured layer to the at least one tool surface; and
supplying a moldable polymeric material into the mold cavity to form the component body in the shape of the mold cavity, wherein the polymeric material contacts the textured layer applied to the at least one tool surface, such that the surface texture of the textured layer is transferred to and formed on the exterior surface of the polymeric component.

2. The method of claim 1 further including the step of decoupling the textured layer and each of the at least one tool surface, such that the textured layer is removed from the tool surface.

3. The method of claim 1 wherein selecting a textured layer having the selected surface texture formed thereon further includes:
applying the selected surface texture to the textured layer, wherein the selected surface texture is applied to the textured layer via one of embossing, debossing, molding, stamping, and laser etching.

4. The method of claim 2 wherein the textured layer covers substantially the entirety of the at least one tool surface.

5. The method of claim 2 wherein:
the at least one tool surface has a first portion and a second portion; and
the textured layer is arranged on the at least one tool surface in a predetermined design, such that the first portion of the at least one tool surface is covered by the textured layer and the second portion of the at least one tool surface is not covered by the textured layer.

6. The method of claim 1 wherein the textured layer is one of a textured film and a textured tape.

7. The method of claim 6 wherein the textured layer is one of a polymer film, a plastic film, a polyimide film, a polyamide film, a polyethylene film, and a thermoplastic polyurethane film.

8. The method of claim 6 wherein the textured layer is one of a textured polyethylene tape, a textured vinyl tape, a textured foil tape, a textured fabric tape, and textured cloth tape.

9. The method of claim 1 wherein the forming tool is one of a injection molding machine, a blow molding machine, a compression molding machine, a thermoforming machine, and a vacuum forming machine.

10. The method of claim 9 wherein the forming tool is an injection molding machine; and wherein supplying the moldable polymeric material into the mold cavity to form the component body further includes injecting the polymeric material into the mold cavity via an injector.

11. The method of claim 9 wherein the forming tool is a blow molding machine; and wherein supplying the moldable polymeric material into the mold cavity to form the component body further includes:
inserting a thermoplastic preform into the mold cavity;
injecting air into the thermoplastic preform via an injector to position the moldable polymeric material such that the moldable polymeric material contacts the textured layer coupled to the at least one tool surface.

12. The method of claim 9 wherein the forming tool is one of a vacuum forming machine and a thermoforming machine; and wherein supplying the moldable polymeric material into the mold cavity to form the component body further includes:
inserting a thermoplastic sheet into the mold cavity;
heating the thermoplastic sheet to a predetermined temperature;
deforming the thermoplastic sheet to the shape of the mold cavity to form the component body, such that the thermoplastic sheet contacts the textured layer coupled to the at least one tool surface;
cooling the deformed thermoplastic sheet; and
trimming excess material from the component body.

13. The method of claim 9 wherein the forming tool is a compression molding machine; and wherein supplying the moldable polymeric material into the mold cavity to form the component body further includes:
inserting the moldable polymeric material into the mold cavity between a first compression molding machine portion and a second compression molding machine portion, wherein the mold cavity is in an open position;
pre-heating the mold cavity to a predetermined pre-heating temperature, when the mold cavity is in the open position;
applying a force to the first compression molding machine portion to transition the mold cavity from an open position to a closed position, such that when the mold cavity is in the closed position the moldable polymeric material contacts the textured layer coupled to the at least one tool surface; and
curing the moldable polymeric material within the mold cavity, wherein curing the moldable polymeric material includes heating the moldable polymeric material to a predetermined curing temperature and applying a predetermined curing pressure to the moldable polymeric material with the first compression molding machine portion and the second compression molding machine portion, when the moldable polymeric material is disposed within the mold cavity.

14. A forming tool comprising:
at least one tool surface, wherein the at least one tool surface defines a mold cavity; and
a textured layer coupled to the at least one tool surface, wherein the textured layer is changeable and removable with respect to the at least one tool surface.

15. The forming tool of claim 14 wherein the textured layer covers substantially the entirety of the at least one tool surface.

16. The forming tool of claim 14 wherein:
the at least one tool surface has a first portion and a second portion; and
the textured layer is arranged on the at least one tool surface in a predetermined design, such that the first portion of the at least one tool surface is covered by the textured layer and the second portion of the at least one tool surface is not covered by the textured layer.

17. The forming tool of claim 14 wherein the textured layer is a textured film, and wherein the textured film is one of a polymer film, plastic film, a polyimide film, a polyamide film, polyethylene film, and a thermoplastic polyurethane film.

18. The forming tool of claim 14 wherein the textured layer is a textured tape, and wherein the textured tape is one of one of a textured polyethylene tape, a textured vinyl tape, a textured foil tape, a textured fabric tape, and textured cloth tape.

19. The forming tool of claim 14 wherein the forming tool is one of a injection molding machine, a blow molding machine, a compression molding machine, a thermoforming machine, and a vacuum forming machine.

20. A polymeric component comprising:
a component body having an exterior surface, wherein the exterior surface has a surface texture formed thereon;
wherein the component body is formed via a forming tool having at least one tool surface, such that the at least one tool surface defines a mold cavity;
wherein the at least one tool surface has a textured layer coupled thereto, such that the textured layer is changeable and removable with respect to the at least one tool surface; and
wherein the textured layer contacts the exterior surface of the component body during forming, such that the surface texture is formed on the exterior surface of the component body during formation via contact between the exterior surface and the textured layer.
